(19) United States
(12) Patent Application Publication
(10) Pub. No.: US 2013/0151813 A1
(43) Pub. Date: Jun. 13, 2013

(54) SWITCH SYSTEM FOR DUAL CENTRAL PROCESSING UNITS

(71) Applicants: WEI PANG, Shenzhen City (CN); YANG LIU, Shenzhen City (CN); CHENG-FEI WENG, Shenzhen City (CN)

(72) Inventors: WEI PANG, Shenzhen City (CN); YANG LIU, Shenzhen City (CN); CHENG-FEI WENG, Shenzhen City (CN)

(73) Assignees: HON HAI PRECISION INDUSTRY CO., LTD., Tu-cheng (TW); HONG FU JIN PRECISION INDUSTRY(ShenZhen) CO., LTD., Shenzhen City (CN)

(21) Appl. No.: 13/483,061

(22) Filed: May 30, 2012

(30) Foreign Application Priority Data
Dec. 13, 2011 (CN) 201110414544.9

(51) Int. Cl. G06F 15/76; G06F 9/02

(52) U.S. Cl. 712/29; 712/E09.002

(57) ABSTRACT

An exemplary switch system includes a first central processing unit (CPU), a second CPU, a first switch unit, a second switch unit, and a microcontroller. The first CPU provides an identification signal to the first switch unit and the second switch unit when the first CPU is associated with a motherboard of an electronic device. Both the first switch unit and the second switch unit selectably and electronically connect to the first CPU or the second CPU according to whether or not both the first switch unit and the second switch unit detect the identification signal. The microcontroller is electronically connected between the first switch unit and the second switch unit, and accordingly communicates with the first CPU or the second CPU via the first switch unit and the second switch unit.

### BACKGROUND

1. Technical field

The disclosure generally relates to switch systems, and particularly to a switch system for dual central processing units (CPUs) of an electronic device.

2. Description of the Related Art

To improve operation efficiency and stability, electronic devices such as servers often employ dual central processing units (CPUs). The dual CPUs are electrically interconnected through a quick path interconnect (QPI) bus. The main CPU of the two CPUs is usually used as a bootstrap processor (BSP), and is electrically connected to a platform controller hub (PCH) through a direct media interface (DMI) bus.

However, with such connections, the dual CPUs are only able to execute bootstrap programs normally when the BSP is installed on a motherboard of the electronic device. When the BSP is not installed on the motherboard, even if the other CPU works properly, the dual CPUs are unable to execute the bootstrap programs normally.

Therefore, there is room for improvement within the art.

### BRIEF DESCRIPTION OF THE DRAWINGS

Many aspects of an exemplary switch system for dual central processing units can be better understood with reference to the drawings. The components in the drawings are not necessarily drawn to scale, the emphasis instead being placed upon clearly illustrating the principles of the disclosure.

FIG. 1 is a block diagram of an electronic device, the electronic device including a switch system for dual central processing units according to an exemplary embodiment.

FIG. 2 is a circuit diagram of one embodiment of the switch system of FIG. 1.

### DETAILED DESCRIPTION

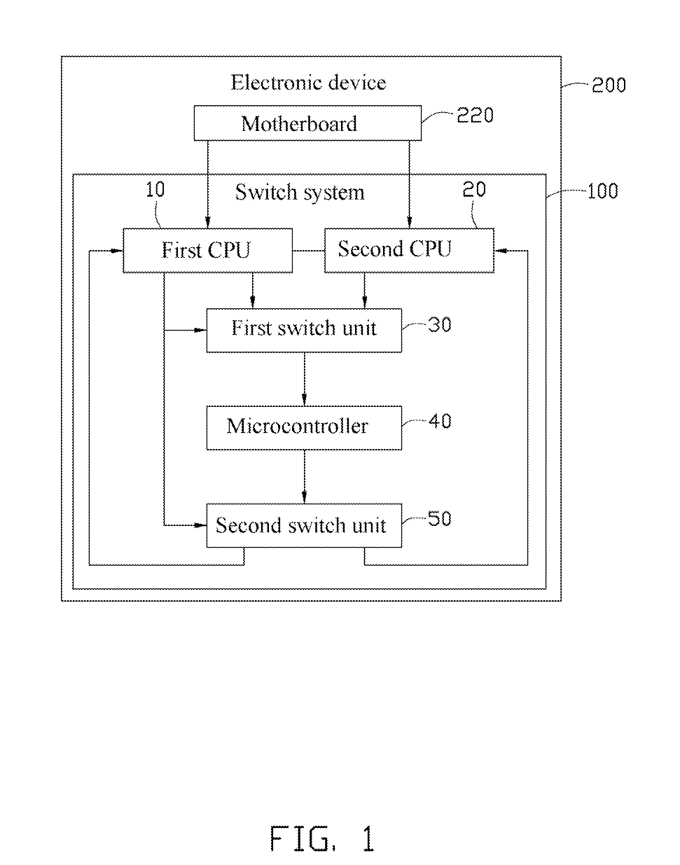

FIG. 1 shows a switch system 100 for dual central processing units (CPUs), used in an electronic device 200. The electronic device 200 can be a server, for example, and further includes a motherboard 220.

The switch system 100 includes a first CPU 10, a second CPU 20, a first switch unit 30, a microcontroller 40, and a second switch unit 50. Both the first CPU 10 and the second CPU 20 are electronically connected to the first switch unit 30 and the second switch unit 50 via a direct media interface (DMI) bus; and the first switch unit 30 and the second switch unit 50 are both electronically connected to the microcontroller 40. Thus, the first CPU 10 and the second CPU 20 can communicate with the microcontroller 40.

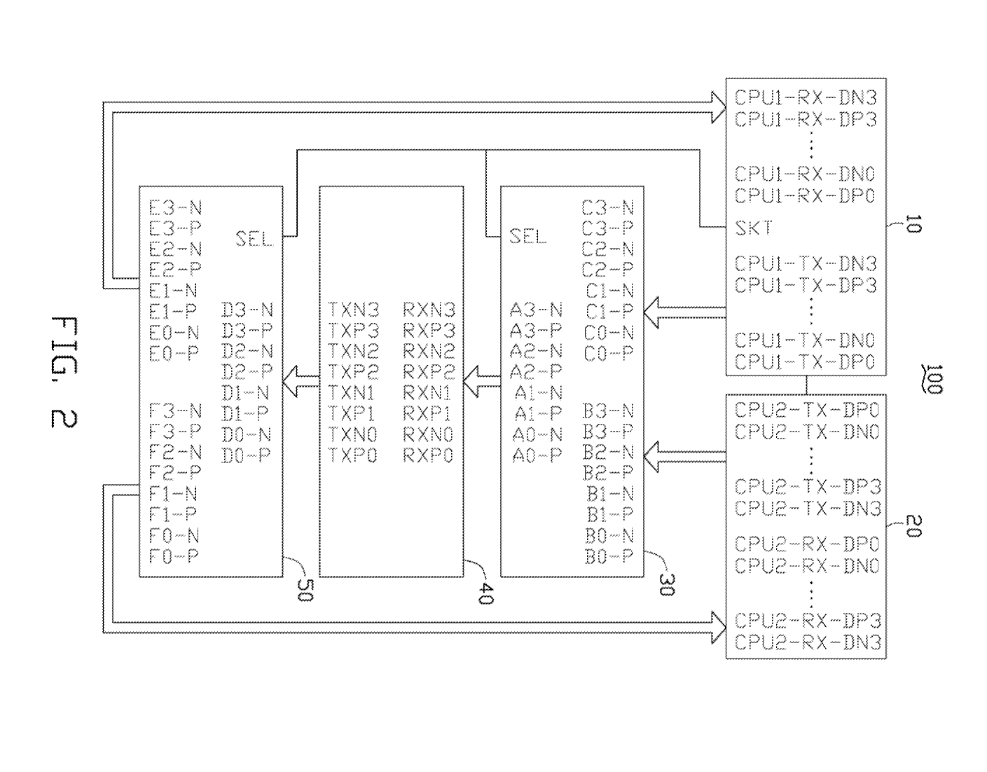

Referring to FIG. 2, in one exemplary embodiment, the first CPU 10 is used as a bootstrap processor (BSP), whose priority is higher than the second CPU 20. The first CPU 10 includes an identification pin SKT. When the first CPU 10 is installed on the motherboard 220, the identification pin SKT outputs an identification signal CPU1-skt. The identification signal CPU1-skt may be a digital signal such as logic “0”, or an analog voltage signal of 2.4V or 3V. The first CPU 10 further includes signal transmission pins CPU1-TX-DP0, CPU1-TX-DP1, CPU1-TX-DP2, CPU1-TX-DP3, CPU1-TX-DN0, CPU1-TX-DN1, CPU1-TX-DN2, CPU1 -TX-DN3, and signal receiving pins CPU1-RX-DP0, CPU1-RX-DP1, CPU1-RX-DP2, CPU1 -RX-DP3, CPU1-RX-DN0, CPU1-RX-DN1, CPU1-RX-DN2, CPU1-RX-DN3. The signal transmission pins CPU1-TX-DP0, CPU1-TX-DP1, CPU1 -TX-DP2, CPU1-TX-DP3, CPU1-TX-DN0, CPU1-TX-DN1, CPU1-TX-DN2, CPU1-TX-DN3 are electronically connected to the first switch unit 30, to output first data signals to the first switch unit 30. The signal receiving pins CPU1-RX-DP0, CPU1-RX-DP1, CPU1-RX-DP2, CPU1-RX-DP3, CPU1-RX-DN0, CPU1-RX-DN1, CPU1-RX-DN2, CPU1-RX-DN3 are electronically connected to the second switch unit 50, to receive second data signals fed back from the microcontroller 40. In one exemplary embodiment, both the first data signals and the second data signals can be 4-way differential signals, which comprise a peripheral component interconnect-express (PCIE) protocol, a DMI protocol, or/and other communication protocols between the CPUs 10, 20 and the microcontroller 40.

The second CPU 20 is electronically connected to the first CPU 10 via a quick path interconnect (QPI) bus. The second CPU 20 includes signal transmission pins CPU2-TX-DP0, CPU2-TX-DP1, CPU2-TX-DP2, CPU2-TX-DP3, CPU2-TX-DN0, CPU2-TX-DN1, CPU2-TX-DN2, CPU2-TX-DN3, and signal receiving pins CPU2-RX-DP0, CPU2-RX-DP1, CPU2-RX-DP2, CPU2-RX-DP3, CPU2-RX-DN0, CPU2-RX-DN1, CPU2-RX-DN2, CPU2-RX-DN3. The signal transmission pins CPU2-TX-DP0, CPU2-TX-DP1, CPU2-TX-DP2, CPU2-TX-DP3, CPU2-TX-DN0, CPU2-TX-DN1, CPU2-TX-DN2, CPU2-TX-DN3 are electronically connected to the first switch unit 30, to output the first data signals to the first switch unit 30. The signal receiving pins CPU2-RX-DP0, CPU2-RX-DP1, CPU2-RX-DP2, CPU2-RX-DP3, CPU2-RX-DN0, CPU2-RX-DN1, CPU2-RX-DN2, CPU2-RX-DN3 are electronically connected to the second switch unit 50, to receive the second data signals fed back from the microcontroller 40.

In one exemplary embodiment, the first switch unit 30 is a multiplexer. The first switch unit 30 transmits the first data signals output from the first CPU 10 or the second CPU 20 to the microcontroller 40 according to the identification signal CPU1-skt.

The first switch unit 30 includes signal input pins C0-P, C0-N, C1-P, C1-N, C2-P, C2-N, C3-P, C3-N, B0-P, B0-N, B1-P, B1-N, B2-P, B2-N, B3-P, B3-N, and signal output pins A0-P, A0-N, A1-P, A1-N, A2-P, A2-N, A3-P, A3-N. The signal input pins C0-P, C0-N, C1-P, C1-N, C2-P, C2-N, C3-P, C3-N are respectively electronically connected to the signal transmission pins CPU1-TX-DP0, CPU1-TX-DP1, CPU1-TX-DP2, CPU1-TX-DP3, CPU1-TX-DN0, CPU1-TX-DN1, CPU1-TX-DN2, CPU1-TX-DN3 of the first CPU 10, to receive the first data signals. The signal input pins B0-P, B0-N, B1-P, B1-N, B2-P, B2-N, B3-P, B3-N are respectively electronically connected to the signal transmission pins CPU2-TX-DP0, CPU2-TX-DP1, CPU2-TX-DP2, CPU2-TX-DP3, CPU2-TX-DN0, CPU2-TX-DN1, CPU2-TX-DN2, and CPU2-TX-DN3 of the second CPU 20, to receive the first data signals.

The first switch unit 30 further includes a selection pin SEL that is electronically connected to the identification pin SKT of the first CPU 10. When the selection pin SEL receives the identification signal CPU1-skt output from the identification pin SKT, the first switch unit 30 controls the signal input pins C0-P, C0-N, C1-P, C1-N, C2-P, C2-N, C3-P, C3-N to electronically connect to the signal output pins A0-P, A0-N, A1-P, A1-N, A2-P, A2-N, A3-P, A3-N, respectively. Thus, the first switch unit 30 outputs the first data signals output from the first CPU 10 via the signal output pins A0-P, A0-N, A1-P, A1-N, A2-P, A2-N, A3-P, A3-N. In contrast, when the selection pin SEL does not receive the identification signal CPU1-skt output from the identification pin SKT, the first switch unit 30 controls the signal input pins B0-P, B0-N, B1-P, B1-N, B2-P, B2-N, B3-P, B3-N to electronically connect to the signal output pins A0-P, A0-N, A1-P, A1-N, A2-P, A2-N, A3-P, A3-N, respectively. Thus, the first switch unit 30 outputs the first data signals output from the second CPU 20 via the signal output pins A0-P, A0-N, A1-P, A1 -N, A2-P, A2-N, A3-P, A3-N.

In one exemplary embodiment, the microcontroller 40 is a platform controller hub (PCH). The microcontroller 40 receives the first data signals transmitted by the first switch unit 30, and feeds back the second data signals to the first CPU 10 or the second CPU 20 via the second switch unit 50. Thus, the microcontroller 40 can communicate with the first CPU 10 or/and the second CPU 20.

The microcontroller 40 includes signal collection pins RXP0, RXN0, RXP1, RXN1, RXP2, RXN2, RXP3, RXN3, and signal feedback pins TXP0, TXN0, TXP1, TXN1, TXP2, TXN2, TXP3, TXN3. The signal collection pins RXP0, RXN0, RXP1, RXN1, RXP2, RXN2, RXP3, RXN3 are respectively electronically connected to the signal output pins A0-P, A0-N, A1-P, A1-N, A2-P, A2-N, A3-P, A3-N, to receive the first data signals. The signal feedback pins TXP0, TXN0, TXP1, TXN1, TXP2, TXN2, TXP3, TXN3 are electronically connected to the second switch unit 50, to feed back the second data signals.

In one exemplary embodiment, the second switch unit 50 is a multiplexer. The second switch unit 50 transmits the second data signals output from the microcontroller 40 to the first CPU 10 or the second CPU 20 according to the identification signal CPU1-skt.

The second switch unit 50 includes signal input pins D0-P, D0-N, D1-P, D1-N, D2-P, D2-N, D3-P, D3-N, and signal output pins E0-P, E0-N, E1-P, E1-N, E2-P, E2-N, E3-P, E3-N, F0-P, F0-N, F1-P, F1-N, F2-P, F2-N, F3-P, F3-N. The signal input pins D0-P, D0-N, D1-P, D1-N, D2-P, D2-N, D3-P, D3-N are respectively electronically connected to the signal feedback pins TXP0, TXN0, TXP1, TXN1, TXP2, TXN2, TXP3, TXN3 of the microcontroller 40, to receive the second data signals. The signal output pins E0-P, E0-N, E1-P, E1-N, E2-P, E2-N, E3-P, E3-N are respectively electronically connected to the signal receiving pins CPU1-RX-DP0, CPU1-RX-DP1, CPU1-RX-DP2, CPU1-RX-DP3, CPU1-RX-DN0, CPU1-RX-DN1, CPU1-RX-DN2, CPU1-RX-DN3 of the CPU 10. The signal output pins F0-P, F0-N, F1-P, F1-N, F2-P, F2-N, F3-P, F3-N are respectively electronically connected to the signal receiving pins CPU2-RX-DP0, CPU2-RX-DP1, CPU2-RX-DP2, CPU2-RX-DP3, CPU2-RX-DN0, CPU2-RX-DN1, CPU2-RX-DN2, CPU2-RX-DN3 of the second CPU 20.

The second switch unit 50 further includes a selection pin SEL that is electronically connected to the identification pin SKT of the first CPU 10. When the selection pin SEL receives the identification signal CPU1-skt output from the identification pin SKT, the second switch unit 50 controls the signal input pins D0-P, D0-N, D1-P, D1-N, D2-P, D2-N, D3-P, D3-N to electronically connect to the signal output pins E0-P, E0-N, E1-P, E1-N, E2-P, E2-N, E3-P, E3-N, respectively. Thus, the second switch unit 50 outputs the second data signals output to the first CPU 10. In contrast, when the selection pin SEL does not receive the identification signal CPU1-skt output from the identification pin SKT, the second switch unit 50 controls the signal input pins D0-P, D0-N, D1-P, D1-N, D2-P, D2-N, D3-P, D3-N to electronically connect to the signal output pins F0-P, F0-N, F1-P, F1-N, F2-P, F2-N, F3-P, F3-N, respectively. Thus, the second switch unit 50 outputs the second data signals to the second CPU 20.

In use of the switch system 100, when only the first CPU 10 is installed on the motherboard 220 or both the first CPU 10 and the second CPU 20 are installed on the motherboard 220, the identification pin SKT outputs the identification signal CPU1-skt. The first switch unit 30 and the second switch unit 50 automatically switch in response to receiving the identification signal CPU1-skt. The first CPU 10 outputs the first data signals to the microcontroller 40 via the first switch unit 30, and the microcontroller 40 feeds back the second data signals to the first CPU 10 via the second switch unit 50.

Thus, effective communication between the microcontroller 40 and the first CPU 10 is enabled. Then, the first CPU 10 executes bootstrap programs normally, or the first CPU 10 and the second CPU 20 execute bootstrap programs normally, to facilitate startup of the electronic device 200.

When only the second CPU 20 is installed on the motherboard 220, the first switch unit 30 and the second switch unit 50 automatically switch in response to not receiving the identification signal CPU1-skt. The second CPU 20 outputs the first data signals to the microcontroller 40 via the first switch unit 30, and the microcontroller 40 feeds back the second data signals to the second CPU 20 via the second switch unit 50. Thus, direct communication between the microcontroller 40 and the second CPU 20 is enabled, and then the second CPU 20 executes bootstrap programs normally to facilitate startup of the electronic device 200.

The first switch unit 30 and the second switch unit 50 can determine whether the first CPU 10 used as the BSP is installed on the motherboard 220, and provide different transmission routes for the first data signals and the second data signals according to the determination of the relationship of the first CPU 10 to the motherboard 220. Then, both the first CPU 10 and the second CPU 20 can communicate with the microcontroller 40 via the first switch unit 30 and the second switch unit 50. Thus, even if the first CPU 10 used as the BSP is not installed on the motherboard 220, the switch system 100 can still allow the bootstrap programs to be executed normally through the second CPU 20. Therefore, the switch system 100 is not only automatic, but also efficient and convenient.

It is to be understood, however, that even though numerous characteristics and advantages of the exemplary embodiments have been set forth in the foregoing description, together with details of the structures and functions of the exemplary embodiments, the disclosure is illustrative only, and changes may be made in detail, especially in the matters of arrangement of parts within the principles of the disclosure to the full extent indicated by the broad general meaning of the terms in which the appended claims are expressed.

What is claimed is:

1. A switch system comprising:
a first central processing unit (CPU) configured for providing an identification signal when the first CPU is associated with a motherboard of an electronic device;
a second CPU;
a first switch unit;
a second switch unit; and
a microcontroller electronically connected between the first switch unit and the second switch unit;
wherein both the first switch unit and the second switch unit selectably and electronically connect to the first CPU or the second CPU according to whether or not both the first switch unit and the second switch unit detect the identification signal, and the microcontroller accordingly communicates with the first CPU or the second CPU via the first switch unit and the second switch unit.

2. The switch system as claimed in claim 1, wherein the first CPU includes an identification pin, and when the first CPU is installed on a motherboard of an electronic device, the identification pin outputs the identification signal.

3. The switch system as claimed in claim 2, wherein each of the first switch unit and the second switch unit includes a selection pin electronically connected to the identification pin to receive the identification signal.

4. The switch system as claimed in claim 3, wherein each of the first CPU and the second CPU includes a plurality of signal transmission pins to output first data signals, and the first switch unit further includes a first plurality of signal input pins electronically connected to the signal transmission pins of the first CPU and a second plurality of signal input pins electronically connected to the signal transmission pins of the second CPU.

5. The switch system as claimed in claim 4, wherein the first switch unit further includes signal a plurality of output pins; when the first CPU is installed on the motherboard, the first switch unit controls the signal output pins to electronically connect to the first plurality of signal input pins; and when the first CPU is not installed on the motherboard, the first switch unit controls the signal output pins to electronically connect to the second plurality of signal input pins.

6. The switch system as claimed in claim 5, wherein the microcontroller includes signal collection pins electronically connected to the signal output pins, to receive the first data signals.

7. The switch system as claimed in claim 6, wherein the second switch unit further includes a plurality of signal input pins, and the microcontroller further includes signal feedback pins electronically connected to the signal input pins of the second switch unit, to feed back second data signals to the second switch unit.

8. The switch system as claimed in claim 7, wherein each of the first CPU and the second CPU includes a plurality of signal receiving pins, and the second switch unit further includes a first plurality of signal output pins electronically connected to the signal receiving pins of the first CPU and a second plurality of signal output pins electronically connected to the signal receiving pins of the second CPU.

9. The switch system as claimed in claim 8, wherein when the first CPU is installed on the motherboard, the second switch unit controls the signal input pins to electronically connect to the first plurality of signal output pins; and when the first CPU is not installed on the motherboard, the second switch unit controls the signal input pins to electronically connect to the second plurality of signal output pins.

10. The switch system as claimed in claim 9, wherein both the first data signals and the second data signals are differential signals.

11. The switch system as claimed in claim 1, wherein both the first switch unit and the second switch unit are multiplexers.

12. The switch system as claimed in claim 1, wherein the microcontroller is a platform controller hub.

13. A switch system comprising:
a first central processing unit (CPU) configured for outputting an identification signal when the first CPU is associated with a motherboard of an electronic device;
a second CPU;
a first switch unit;
a second switch unit; and
a microcontroller electronically connected between the first switch unit and the second switch unit;
wherein both the first switch unit and the second switch unit electronically connect to the first CPU when both the first and second switch units detect the identification signal output from the first CPU, and the microcontroller communicates with the first CPU accordingly; and
wherein both the first switch unit and the second switch unit electronically connect to the second CPU when both the first and second switch units detect no identification signal output from the first CPU, and the microcontroller communicates with the second CPU accordingly.

14. The switch system as claimed in claim 13, wherein the microcontroller receives first data signals from the first CPU or the second CPU via the first switch unit, and outputs second data signals to the first CPU or the second CPU correspondingly via the second switch unit.

15. The switch system as claimed in claim 14, wherein both the first data signals and the second data signals are differential signals.

16. The switch system as claimed in claim 13, wherein both the first switch unit and the second switch unit are multiplexers.

17. A switch system comprising:
a first central processing unit (CPU) configured for providing an identification signal and first data signals, the first CPU providing the identification signal when the first CPU is associated with a motherboard of an electronic device;
a second CPU configured for providing the first data signals;
a first switch unit;
a second switch unit; and
a microcontroller electronically connected between the first switch unit and the second switch unit;
wherein when both the first switch unit and the second switch unit detect the identification signal, the microcontroller receives the first data signals from the first CPU via the first switch unit, and feeds back second data signals to the first CPU via the second switch unit; and
wherein when both the first switch unit and the second switch unit do not detect the identification signal, the microcontroller receives the first data signals from the second CPU via the first switch unit, and feeds back second data signals to the second CPU via the second switch unit.

18. The switch system as claimed in claim 17, wherein the first CPU includes an identification pin, and when the first CPU is installed on the motherboard, the identification pin provides the identification signal.
